(19) United States
(12) Patent Application Publication
(10) Pub. No.: US 2015/0032645 A1
(43) Pub. Date: Jan. 29, 2015

(54) COMPUTER-IMPLEMENTED SYSTEMS AND METHODS OF PERFORMING CONTRACT REVIEW

(71) Applicant: The Trustees of Columbia University in the City of New York, New York, NY (US)

(72) Inventors: KATHLEEN R. MCKEOWN, Wayne, NJ (US); JACOB MUNDT, New York, NY (US); BARRY SCHIFFMAN, New York, NY (US)

(21) Appl. No.: 14/455,419

(22) Filed: Aug. 8, 2014

Related U.S. Application Data
(63) Continuation of application No. PCT/US13/26131, filed on Feb. 14, 2013.
(60) Provisional application No. 61/600,420, filed on Feb. 17, 2012.

(51) Int. Cl. G06F 17/30; G06Q 50/18

(52) U.S. Cl. CPC G06F 17/30719; G06F 17/30011; G06Q 50/18
USPC 705/311

(57) ABSTRACT

The presently disclosed subject matter provides techniques for the automation of legal document review and creation of summary documents. The disclosed subject matter can be operated in training mode or classification mode. A preprocessor generates candidate items and associated features from input documents. Candidate items can be presented to a machine learning classifier, which classifies them as relevant or not relevant to a given legal category. A summary document can be provided including the relevant candidates.

### CROSS REFERENCE TO RELATED APPLICATION

This application is a continuation of International Patent Application No. PCT/US13/026131, filed Feb. 14, 2013, and claims priority to U.S. provisional application No. 61/600,420, filed Feb. 17, 2012, to both of which priority is claimed and the contents of both of which are incorporated herein in their entireties.

### BACKGROUND

The task of reviewing contracts, for example as part of due diligence performed during the merger or sale of a company, is often performed by humans who manually review a set of relevant documents. Certain provisions of these contracts can be of particular interest, including the effective date of the contract, the names of the parties involved, provisions governing assignments, and indemnity.

Attorneys can access these documents as either individual files or through a document management system at the law firm. The documents can be stored in the form of PDFs, Word documents, or plain text documents. The attorney scans through the document to locate the relevant provisions, either by reading through the document or by relying on text searches on certain keywords (e.g. “assignment” or “indemnify”). The attorney can also rely on the fact that contracts can sometimes contain section headings which can help find these provisions, though care must be taken as relevant provisions often appear in other sections in the document as well. An attorney performing such a review can create an executive summary document, listing the various contracts with their parties and provisions, for review by senior attorneys, decision makers, or clients.

A purpose of legal due diligence is to alert a potential acquirer, investor or lender to any material or problematic provisions contained within a company's legal documents. In large transactions, legal due diligence can entail attorneys reviewing hundreds or thousands of documents that have been uploaded to virtual data rooms. In addition to identifying red flag provisions, the attorneys are often charged with summarizing key provisions from the documents in a template form.

This process can be expensive, time consuming, and prone to human error. Accordingly, there remains a need for automated techniques for contract review.

### SUMMARY

The presently disclosed subject matter provides methods and systems for the automation of document review and the production of summaries identifying the key information contained in each reviewed document.

In one embodiment of the disclosed subject matter, techniques include a training mode and a classification mode.

The training mode can include having legal documents annotated by attorneys using a suitable tool. In this way the relevant sections of each document can be classified by a human annotator. Annotated documents can then submitted to the preprocessor, which generates candidate items according to a candidate selection strategy. Because the candidates have been pre-marked by hand as relevant or irrelevant, a machine learning classifier can use this information to learn which features can be used to predict relevancy, and to assign corresponding weights to each feature.

The classification mode can include preprocessing non-annotated documents to generate candidates. Candidates can be generated according to a candidate selection strategy. The candidate selection strategy can be dependent on the legal provision sought to be extracted. Candidates contain features, which are attributes associated with the candidate item. Once the candidates are generated, a trained machine learning classifier can be used to determine each candidate's relevancy, based on the features associated with the candidate. Once all of the candidates items have been processed, relevant candidates can then presented to a user, for example, in the form of a summary. The trained machine learning classifier updates itself with the new information it has learned.

In another aspect, techniques are provided that process different types of legal documents differently, which can lead to improved accuracy. Additionally, the accuracy of a classification can be estimated.

In other embodiments, the user can select the degree of context to be included in the summary document, summarize certain candidate items, and/or cross-reference candidate items with each other.

The disclosed subject matter also provides methods for managing sets of legal documents. Documents can be grouped by certain characteristics and/or searched and filtered according to their characteristics.

### BRIEF DESCRIPTION OF THE DRAWINGS

FIG. 1 is a diagram of one embodiment of the disclosed subject matter in training mode.

FIG. 2 is a diagram of one embodiment of the disclosed subject matter in classification mode.

FIG. 3 is a block diagram of an embodiment of the disclosed subject matter showing an exemplary document management system.

FIG. 4 is a block diagram of an alternative embodiment of the disclosed subject matter.

FIG. 5 is a diagram of an alternative embodiment of the disclosed subject matter in classification mode.

FIG. 6 is a diagram of example classes and methods of the disclosed subject matter.

Throughout the drawings, the same reference numerals and characters, unless otherwise stated, are used to denote like features, elements, components or portions of the illustrated embodiments. Moreover, while the disclosed subject matter will now be described in detail with reference to the Figs., it is done so in connection with the illustrative embodiments.

### DETAILED DESCRIPTION

The disclosed subject matter provides methods and systems for automation of review of legal documents and production of summaries of those documents. From a document, or a collection of documents, sentences can be extracted that can correspond to legal provisions that the user wishes to see in a summary. In this manner the task of legal document review can be simplified for the user, as the disclosed subject matter can extract the relevant portions of the document quickly and automatically. Additionally, because the disclosed subject matter can utilize a machine learning technique, the accuracy of extraction can increase as additional documents are processed.

The legal provisions that can be extracted according to the presently disclosed subject matter can include, but are not limited to: Applicable Defined Terms, Arbitration, Change of Control/Assignment, Compensation, Confidentiality, Date of Agreement, Employee Job Description, Employee Title, Events of Default, Exclusivity, Field, Force Majeure, Governing Law, Indemnification, Injunctive Relief, Insurance, Jurisdiction, Limitation on Liability, Most Favored Nation, Non-Compete, Non-Solicit, Notice, Option to Purchase, Parties, Pre-Payment, Pricing, Restrictive Covenants, Survival, Tax, Term, Termination and Renewal, Territory, Third Party Beneficiaries, Title of Agreement, and Warranty.

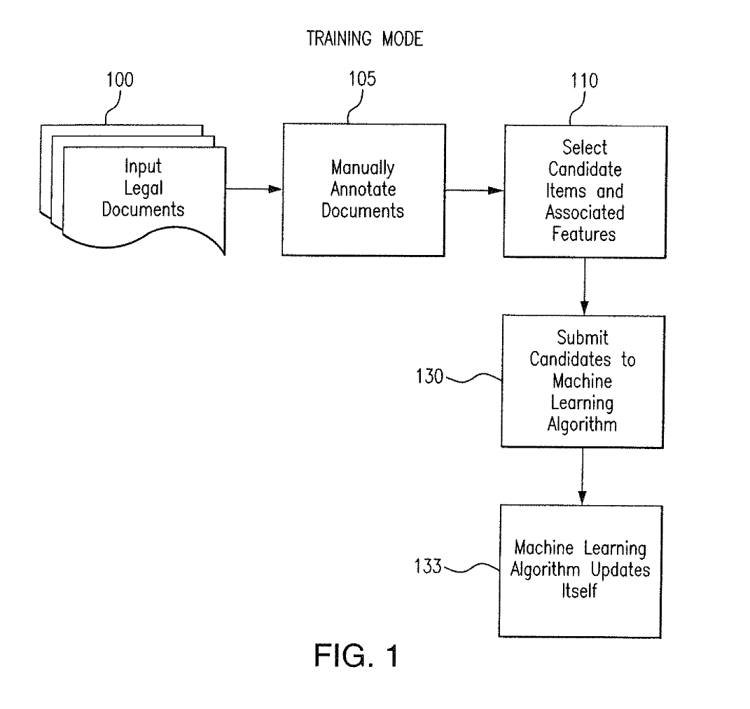

FIG. 1 provides an example of the training mode according to the disclosed subject matter. Legal documents 100 can be annotated using a linguistic annotation tool 105, for example and without limitation, the Callisto tool, available from the Mitre Corporation. Using the tool 105, the relevant provisions of the document can be marked and categorized according to their legal category. For example, the human annotator can determine the names of the parties involved, and can mark them as such using the tool 105. Documents annotated in this manner can be submitted to a preprocessor 110. The preprocessor 110 can generate candidate items 120, which have already been marked as relevant or irrelevant by human annotators using the linguistic annotation tool 105. Candidate items 120 can be any potentially relevant element of a legal document. For example, a candidate item 120 can be a sentence in a document. Alternatively, a candidate item 120 can be a date, a company name, a personal name, or any other textual element of a document. Candidate items 120 can have associated features, which can be attributes describing the candidate item - for example, a feature can be the words in the candidate item, or the candidate item's position in the document.

Candidate items 120 can be presented, by a processing arrangement, to a machine classifier 130, for example and without limitation, the Waikato Environment for Knowledge Analysis (WEKA). The machine learning classifier 130 can analyze the candidate items 120 to learn which features best characterize candidate items for a given legal category. The machine learning self-updating process 133 can take place without additional user or system supervision. In this manner, the machine classifier 130 can learn which candidate features are the best for predicting whether a candidate provision is relevant or irrelevant, which can enable the machine classifier 130 to process documents which have not been pre-annotated.

In another embodiment of the training mode, the machine learning algorithm can utilize a semi-supervised machine learning algorithm, which can enable the system's training mode (as illustrated in FIG. 1) to rely on a mixture of annotated and un-annotated documents. For example, a suitable algorithm can be a C4.5 decision tree algorithm, as described in J. Ross Quinlan, C4.5: Programs for Machine Learning (1993). Additionally, Naïve Bayes or Bayesian Network classifiers can be used.

With reference to FIG. 1, the preprocessor 110 can select candidate items from the legal document 100 for a given legal provision. The preprocessor 110 can perform this task according to a candidate selection strategy. The candidate selection strategy can be, for example, selecting each sentence in a document as a candidate. Alternatively, the candidate selection strategy can use a named entity extractor, for example and without limitation, the Stanford Named Entity Recognizer. The preprocessor 110 also generates a plurality of features associated with each candidate. Features are attributes of each candidate item, and can be used by the machine classifier 130 to determine whether a candidate item is relevant or irrelevant to each category. Candidate item features can include, for example and without limitation, words and other textual content, positional features (e.g. where in the document is the candidate item located), named entity features (e.g. named entities are usually capitalized or contain words such as Inc.), and any other suitable attribute. The machine classifier 130 can determine by itself the weight assigned to each of the features, depending on how well they predict the correct classification of the candidate item.

The machine learning classifier 130 can be any suitable machine learning classifier tool, for example WEKA, a well-known open-source machine learning tool. In addition to classifying the candidate item as relevant or irrelevant to a given legal category, the machine learning classifier can update itself with the new information, which can result in more accurate future classification. The machine learning classifier 130 can classify candidate items by examining their features. The classifier 130 can learn which features best characterize each legal category, enabling the classifier 130 to continually improve the accuracy of its classification as it processes new documents over time.

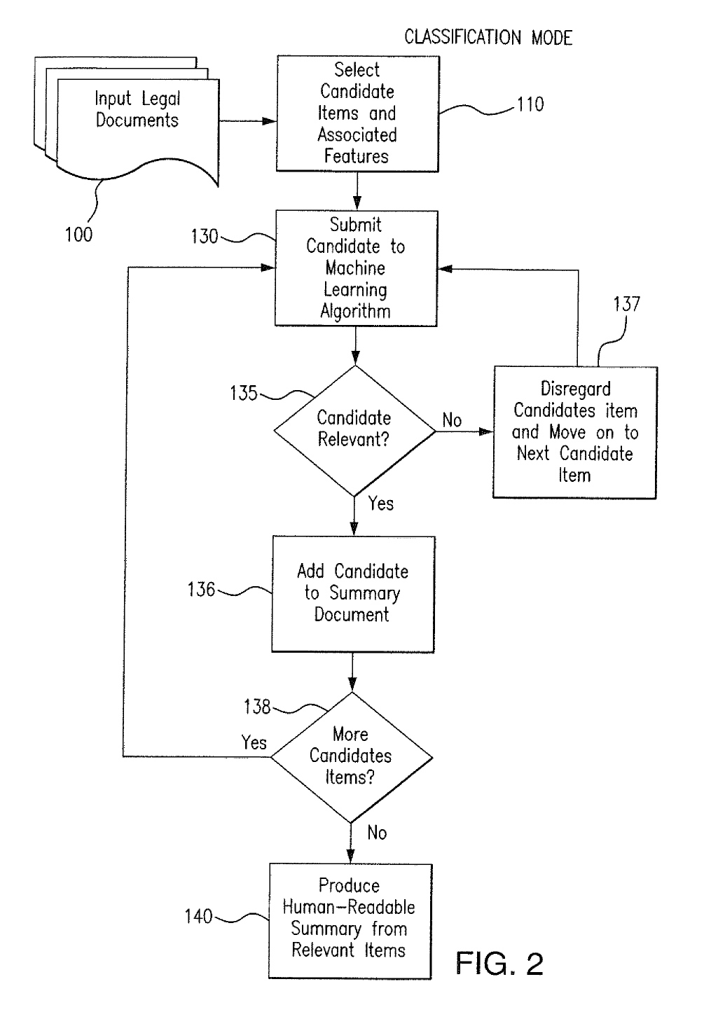

FIG. 2 shows a diagram of the classification mode of the disclosed subject matter. A document, or a set of documents 100 in computer readable format, can be presented to the preprocessor 110. In contrast to the training mode of FIG. 1, in classification mode the documents are presented without having previously been annotated by human annotators. The documents 100 can be presented to the system by a user choosing the document from a list, or the system can scan designated folders on a regular basis to determine if any new documents exist which can be processed.

The preprocessor 110 can generate candidates according to a candidate selection strategy. The strategy for selecting candidates can depend on the legal provision that is sought to be extracted—for example and without limitation, the candidate selection strategy for extracting the effective date of a contract can comprise finding candidate items 120 with features such as names of months or four-digit numbers contained therein. The preprocessor 110 can also generate a plurality of features associated with each candidate. Candidate items 120 selected in this manner can then be presented by the preprocessor 110, using a processing arrangement, to a machine classifier 130. In classification mode, the machine classifier 130 has already been trained according to the methods and procedures described with reference to FIG. 1. The classifier 130 can apply the knowledge gained through the training mode, or previous instances of the classification mode, to classify each candidate item 120 as relevant or irrelevant 135 to a particular legal category. Relevant candidate items 120 can be compiled, using a processing arrangement 136, into a human-readable summary document 140. Irrelevant candidates 137 can be discarded, and the processing arrangement 138 can examine the next candidate item. This analysis can repeat iteratively until all candidate items 120 have been examined.

The feature selection process can include, for example, determining whether each candidate item 120 is relevant or not relevant through the use of candidate features. Features can include words, word bigrams (pairs of adjacent words), positional features, named entity features, or any other document content. In some embodiments, filtering techniques can be used to simplify feature selection. By way of example and not limitation, words in a candidate item 120 can be filtered to include only the most frequently occurring words in a given legal category. Additionally, horizontal rules can be captured near the candidate item 120 for purposes of identifying signature blocks and other specific sections of the document. In some embodiments, the presence of other named entities, for example dates, companies, and people, can be features, as some sentences can be more likely to contain company names or person names than other sentences. In other embodiments, machine learning techniques can be used to identify section headings, which can improve the accuracy of the classification. For example, when looking for a Change of Control provision, the word “merger” can appear throughout the document and is thus not indicative that a given passage can contain the Change of Control provision. If, however, the word “merger” can appear in a section titled “Assignment”, the section heading can be an additional feature that can indicate that this particular instance can be relevant. This is because a section heading can often be a useful tool for locating and classifying certain legal provisions.

Features are thus any information concerning a candidate item that has a predictive effect on said candidate's relevancy to a given legal category. For example, an indemnification provision can often include the word “indemnify” or variations thereof.

According to one embodiment, the methods and systems provided herein can be made accessible to the user through a webpage or another Internet portal. The electronic documents that function as input can be submitted by any method known in the art, for example, documents being submitted individually, as sets of documents, as contents of a folder, or any other suitable method known in the art. According to the presently disclosed subject matter, the documents that can be summarized by the disclosed subject matter can include Microsoft Word documents, plain text documents, text-searchable PDF documents, scanned PDF documents, TIFF documents, or any other suitable machine-readable document format.

In another aspect of the disclosed subject matter, a tool is provided for users to review or edit the extracted text within the source document. Editing the document in this manner allows the user to add content to the summary 140, without affecting the machine learning classifier 130, which will not use the edits to modify its internal calibration. According to another aspect, the user can add or delete entire sentences from the summary 140. By doing this, the addition or subtraction of sentences is incorporated into the machine learning classifier 130.

According to another aspect of the disclosed subject matter, the user can select the amount of information to be included in the summary 140, on a scale from 1 to 3. Selecting 1 can extract only the most relevant candidate items for each legal provision. Selecting 3 can extract additional sentences concerning each legal provision, even if they were classified as less relevant. For example, with respect to indemnification, selecting 1 can extract only the candidate item or items which describe when and if indemnification is triggered, whereas selecting 3 can also include sentences describing the process for seeking indemnification or other contextual information.

According to another aspect of the disclosed subject matter, the sentences in the summary 140 can be summarized further. For example, the sentence “Buyer shall indemnify Seller for any claim, cost, expense, damage, or loss related to the contract.” can be further summarized as “Buyer shall indemnify Seller for any damage related to the contract.”

According to another aspect of the disclosed subject matter, the user can select the type of legal document to be summarized. For example, to review an employment agreement, or a set of employment agreements, the user can choose “Employment Agreement” from a menu. The user can then be presented with a list of legal provisions to select, including some provisions specific to employment agreements, such as Compensation or Benefits. This approach can improve the accuracy of classification, as the system can learn the different features that characterize different types of legal documents.

According to another aspect, the user can cross-reference to other sections in the source document that reference the extracted section. For example, if information on indemnification is extracted from Section 6.4, the user can link to or review other sections that reference Section 6.4. For example, if Section 7.1 stated “Notwithstanding Section 6.4, Buyer shall . . . ”, then Sections 6.4 and 7.1 can be cross-referenced.

According to another aspect of the disclosed subject matter, a quantitative confidence rating can be generated for each extracted sentence, indicating how accurate the extraction is deemed by the system. The rating can be a numerical grade (e.g. 1-5). For example, a confidence rating can be “5” for a passage that is very likely related to the provision, while the confidence rating can be “2” for a passage that has only a small chance of being related.

According to another aspect of the disclosed subject matter, a tool permitting the user to report problems or issues with the system to is provided. For example, a support page can be provided that can give phone and email contact information that can be used to report problems.

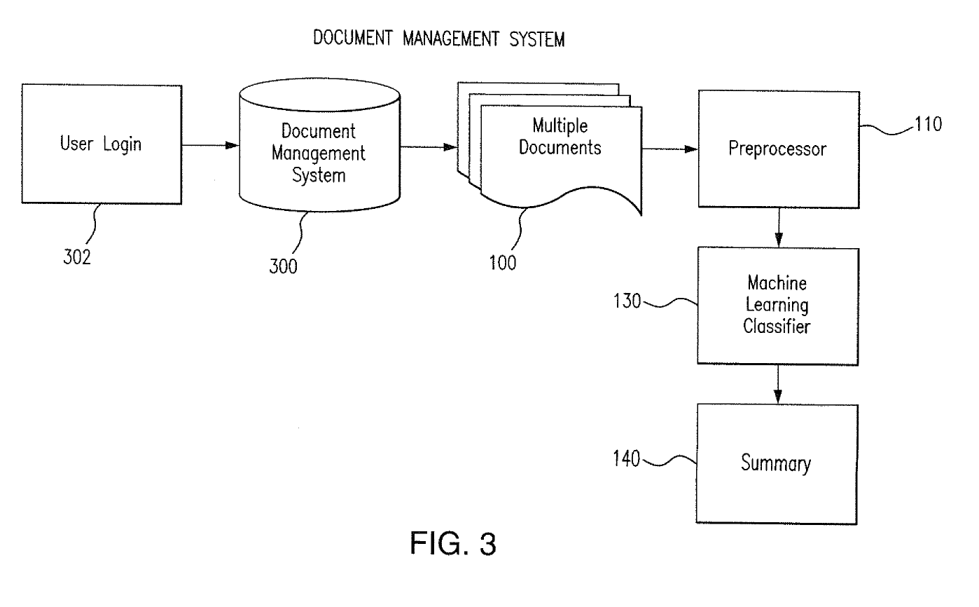

In another embodiment, a document management system 300 can be provided, as illustrated for example in FIG. 3. The document management system 300 can be a repository of legal documents. For example, a repository can be a local file server or a remote file server, or it can be a database management system. Documents 100 can be searched or filtered by the user. Additionally, documents 100 can be located using automated scans of designated folders or drives on a regular basis. If the scan determines that new documents have been added, it can submit them to the system, ensuring that they are reviewed and processed accordingly. According to another aspect of the disclosed subject matter, documents 100 stored in the document management system 300 can be filtered by any relevant field. For example, documents can be filtered so that only documents containing an effective date during a certain time period are identified. Alternatively, the documents can be filtered, for example, to show only those documents which contain a governing law provision that identifies the governing law as that of New York.

Documents 100 stored in the document management system 300 can be searched in a number of ways, for example by using a Boolean search, a proximity search or a fuzzy logic search. For example, a search for the named party “General Electric” can return documents in which General Electric is a named party, and not all documents in which General Electric is merely mentioned by name, as with an ordinary plain text search.

According to another aspect, the system can maintain separate user logins 302 for each user, as illustrated by way of example in FIG. 3. Separate user logins 302 can allow the system to apply the preprocessing 110 and machine learning module 130 separately for each user. In this manner, the system can be customized for each user. For example, if a certain user demands only basic information regarding indemnification, but detailed information regarding pricing, the system can learn and self-adjust to provide the desired amount of detail for that user.

In another aspect, the disclosed subject matter can indicate whether a set of documents 100 stored in the document management system 300 are substantially similar or how they vary from a “form” document. For example, an employment agreement folder can contain a number of employment agreements that can be identical but for the employee name and their compensation. The system can provide a summary indicating the changes between documents, allowing the user to review only those parts of the document that have changed.

In another aspect of the disclosed subject matter, a summary table can be generated for sets of documents 100 stored in the document management system 300. The table can provide a summary of the documents 100 in the set, including a summary of the provisions selected by the attorney, indicating whether or not a certain provision was identified in the particular document. If the sought provision was found, a hyperlink can be provided to take the user from the table to the relevant portion in the original document. According to another aspect, the system can indicate how many documents within a set contain a particular type of clause. For example, if 18 of the documents within a set contain a Change of Control provision, the document management system 300 can indicate that with a number 18. A hyperlink can be provided to open this list of 18 documents when selected by the user. An example summary table is provided below.

TABLE 1

| | Assignment | |
|---|---|---|
| | & Change | |
| Document | of Control | Indemnification |
| Doc_001_Employment_Agreement_6.1.09 | Provision | None |
| | identified | identified |
| Doc_002_Agreement_1.24.00 | Provision | Provision |
| | identified | identified |
| Doc_003_Employment_Agreement_5.20.11 | Provision | Provision |
| | identified | identified |

According to another aspect of the disclosed subject matter, the documents and computer communication used by the disclosed subject matter can utilize encryption in order to ensure security and prevent unauthorized access. The encryption can be, for example, Secure Sockets Layer (SSL) 128-bit end-to-end encryption, or any other suitable encryption technique.

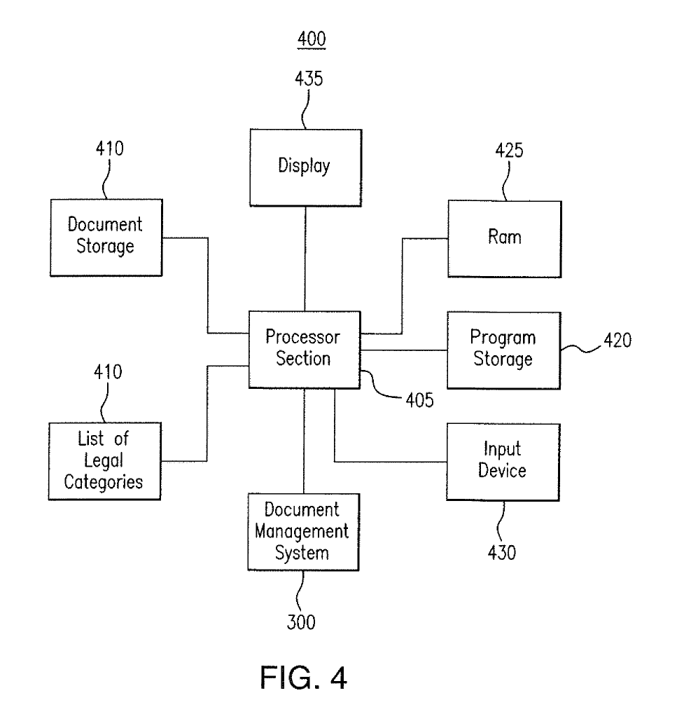

FIG. 4 is a simplified block diagram of a system in accordance with the disclosed subject matter. The system 400 includes a processor section 405 wherein the processing operations set forth in FIGS. 1,2,4,5, and 6 are performed. The system also includes non-volatile storage coupled to the processor section 405 for document storage 410, a list of legal categories 415, a document management system 300 and program storage 420. Generally these storage systems are read/write data storage systems, such as magnetic media and read/write optical storage media. However, the document collection storage can take the form of read-only storage, such as a CD-ROM storage device. The system further includes RAM memory 425 coupled to the processor section for temporary storage during operation. The system 400 will generally include one or more input device 430 such as a keyboard, digitizer, mouse and the like, which is coupled to the processor section 405. Similarly, a conventional display device 435 is generally provided which is also operatively coupled to the processor section.

For example, a document 100 can be retrieved from document storage 410 using an input device 430 and a display 435. Temporary working memory storage is provided by the RAM 425. The methods and techniques according to the disclosed subject matter can be implemented as instructions read by the processor section 405. The list of legal categories 415 can be stored separately from the document storage 410. The processor 405 can then apply the methods and techniques according to the present disclosure and produce a summary 140. A document management system 300 can be used for sets of documents 100.

The particular hardware embodiment is not critical to the practice of the disclosed subject matter. Various computer platforms and architectures can be used to implement the system 400, such as personal computers, workstations, networked computers, and the like. The functions described in the system can be performed locally or in a distributed manner, such as over a local area network or the Internet. For example, the document storage 310 can be at a remote archive location which is accessed by the processor section 305 via a connection to the Internet. Although the disclosed subject matter has been described in connection with specific exemplary embodiments, it should be understood that various changes, substitutions and alterations can be made to the disclosed embodiments without departing from the spirit and scope of the disclosed subject matter as set forth in the appended claims.

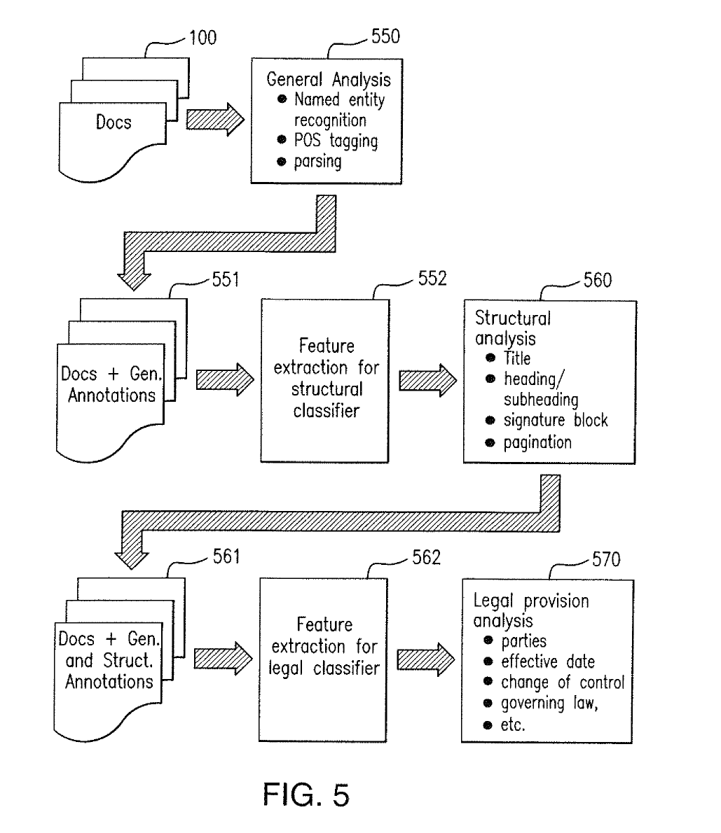

FIG. 5 is a diagram of another embodiment of the presently disclosed subject matter, in classification mode. A general machine learning classifier 550 is presented with documents 100. The general machine learning classifier 550 can produce a document 551 containing general annotations. For example, a suitable classifier 550 can be the Stanford part of speech tagger, available at http://nlp.stanford.edu/software/tagger.shtml. For example, the classifier 550 can identify and tag parts of speech in the document 100.

The resulting document 551 can then be presented to a structural feature extractor 552. The extractor 552 can extract features of documents 100 that can be relevant to determining what role each piece of text can play in the document. For example, a structural feature can be whether a piece of text is lowercase, title case, or all caps; whether it is underlined, in boldface, indented, bulleted; how long the text is; or particular words contained in the text (for example, “section”). Once the structural feature extractor 552 extracts relevant features, the document can be presented to a structural machine learning classifier 560. The classifier 560 can produce a document 561 with general and structural annotations. For example, the classifier 560 can analyze structural features of the document 100, such as the title or subheadings.

The resulting document 161 can be presented to a legal feature extractor 562. For example, the legal feature extractor 562 can extract positional features (for example, where a sentence can appear within a document or within a section), words contained in a sentence, word bigrams and trigrams, and word - part of speech pairs. The legal feature extractor 562 can analyze features such as, for example, change of control provisions or governing law provisions. The resulting document is presented to a legal machine learning classifier 570, which can make a final determination about whether the candidate items 120 in a given document are relevant or irrelevant to a given legal category.

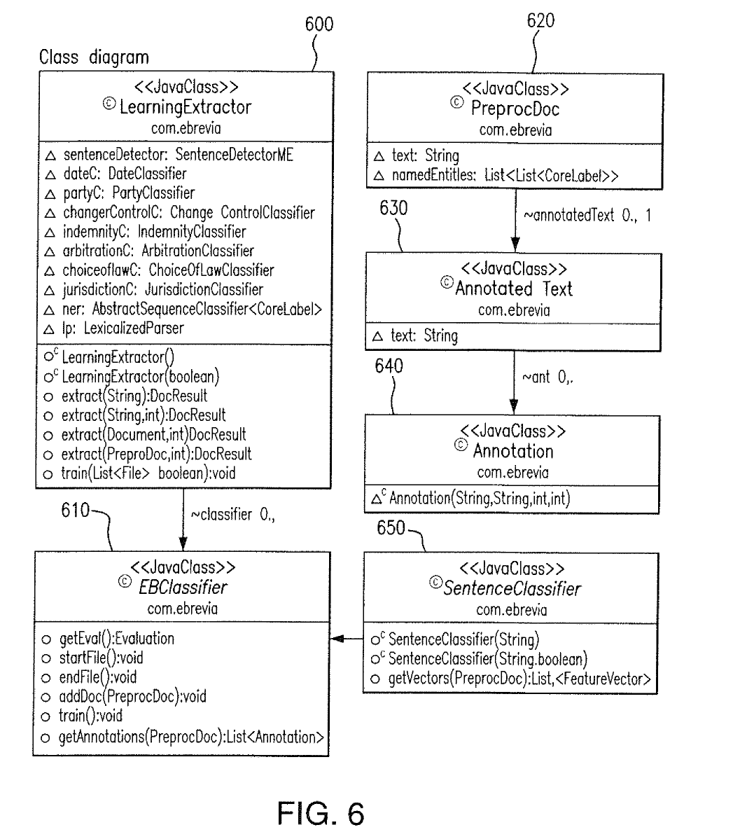

FIG. 6 is a diagram of example classes and methods according to the presently disclosed subject matter. The class LearningExtractor 600 can be used to call a machine learning classifier, or to train a classifier using annotated documents. LearningExtractor 600 can be descended from the class EBClassifier 610, which can be a parent class that can accept annotated documents in training mode or unlabeled documents in classification mode. SentenceClassifier 650 can be a parent class for all classifiers which operate at the sentence level, and can be descended from the class EBClassifier 610.

By reference to FIG. 6, Class PreprocDoc 620 can store annotations in a class AnnotatedText 630. Objects of PreprocDoc 620 have had non-legal classification and preprocessing performed on them. Class AnnotatedText 630 can be descended from class Annotation 640. Class AnnotatedText 630 can be used to store the text of a document with a set of legal annotations.

As described above in connection with certain embodiments, a computer 400 is provided to perform document review and generate summaries used by attorneys and others. In these embodiments, the computer 400 plays a significant role in permitting the systems and methods describe herein to generate a human-readable summary from one or more electronic documents. For example, the presence of the computer 400 provides machine learning capacity, and improves the accuracy of results while reducing errors.

The presently disclosed subject matter is not to be limited in scope by the specific embodiments herein. Indeed, various modifications of the disclosed subject matter in addition to those described herein will become apparent to those skilled in the art from the foregoing description and the accompanying figures. Such modifications are intended to fall within the scope of the appended claims.

1. A method for generating a human-readable summary from one or more electronic documents comprising:
selecting, using a processing arrangement, one or more candidate items from the one or more electronic documents, each having at least one corresponding associated feature;
classifying each of the one or more candidate items as relevant or irrelevant to a category, based on the at least one corresponding associated feature; and
producing a human-readable summary comprising the each of the one or more candidate items classified as relevant.

2. The method of claim 1, wherein the category is selected from the group consisting of: Applicable Defined Terms, Arbitration, Change of Control/Assignment, Compensation, Confidentiality, Date of Agreement, Employee Job Description, Employee Title, Events of Default, Exclusivity, Field, Force Majeure, Governing Law, Indemnification, Injunctive Relief, Insurance, Jurisdiction, Limitation on Liability, Most Favored Nation, Non-Compete, Non-Solicit, Notice, Option to Purchase, Parties, Pre-Payment, Pricing, Restrictive Covenants, Survival, Tax, Term, Termination and Renewal, Territory, Third Party Beneficiaries, Title of Agreement, and Warranty.

3. The method of claim 1, wherein the electronic document comprises a legal contract.

4. The method of claim 1, wherein selecting one or more candidate items comprises using a candidate selection strategy.

5. The method of claim 1, wherein the at least one corresponding associated feature is selected using feature selection.

6. The method of claim 1, wherein the classifying comprises a machine learning classification.

7. The method of claim 6, wherein the at least one feature comprises an assigned numerical weight, selected to improve the machine learning classification.

8. The method of claim 6, further comprising training the machine learning classification separately for a plurality of types of electronic documents.

9. The method of claim 6, further comprising training the machine learning classification separately for each of a plurality of users.

10. The method of claim 1, wherein the producing further comprises selecting an amount of context.

11. The method of claim 1, wherein each of the one or more candidate items classified as relevant are cross-referenced with one or more additional portions of the one or more electronic documents.

12. The method of claim 1, further comprising producing a confidence rating for the each of the one or more candidate items classified as relevant.

13. The method of claim 1, further comprising generating a measure estimating the deviation of the one or more electronic document from a standard form document.

14. A computer system for generating a human-readable summary from one or more electronic documents, comprising:
a first processing arrangement adapted to receive the electronic document and select one or more candidate items from the one or more electronic documents, each having at least one corresponding associated feature;
a machine learning classifier, operatively coupled to the first processing arrangement, to classify each of the one or more candidate items as relevant or irrelevant to a category, based on the at least one corresponding associated feature; and
a second processing arrangement, operatively coupled to the machine learning classifier, adapted to compose a one or more summary documents from the one or more candidate items classified as relevant.

15. The system of claim 14, wherein the machine learning classifier is operable in a training mode and a classification mode.

16. The system of claim 14, wherein the first processing arrangement comprises a named entity extractor.

17. The system of claim 14, further comprising a computer-readable medium, operatively coupled to the first processing arrangement, for storing the relevant candidate items.

18. A computer readable storage medium having data stored therein representing software executable by a computer, the software including instructions for generating a human-readable summary from one or more electronic documents, the storage medium comprising:
instructions for selecting, using a processing arrangement, one or more candidate items from the one or more electronic documents, each having at least one corresponding associated feature;
instructions for classifying each of the one or more candidate items as relevant or irrelevant to a category, based on the at least one corresponding associated feature; and
instructions for producing a human-readable summary comprising the each of the one or more candidate items classified as relevant.
